(19) United States
(12) Patent Application Publication
(10) Pub. No.: US 2006/0148935 A1
(43) Pub. Date: Jul. 6, 2006

(54) POLYVINYL CHLORIDE BLEND

(76) Inventor: John E. DAVIDSAVER, Cuyahoga Falls, OH (US)

Correspondence Address: BUCKINGHAM, DOOLITTLE & BURROUGHS, LLP, 50 S. MAIN STREET, AKRON, OH, 44308, US

(21) Appl. No.: 10/905,440

(22) Filed: Jan. 4, 2005

(51) Int. Cl. B29C 47/00

(52) U.S. Cl. 524/13; 524/565

(57) ABSTRACT

A process and polyvinyl chloride composition which results from the process whereby a simultaneous improvement in two physical properties is achieved, namely an increase in heat distortion temperature with decrease in coefficient of expansion, effected through the blending of a copolymer derived from a vinylaromatic monomer, preferably alpha-methyl styrene and derived from an ethylenically unsaturated cyano monomer, preferably acrylonitrile with less than 20% wood flour.

### TECHNICAL FIELD

This invention relates generally to blends of polyvinyl chloride (“PVC”) which combines the properties of low coefficient of thermal expansion and high heat distortion temperature for use in conjunction with metal surfaces.

### BACKGROUND OF THE INVENTION

Garage doors are one of the largest moving devices that get used several times per day. Not only is a garage door big and useful, but manufacturers are additionally trying to improve the aesthetics of the door at a cost-effective price.

This invention was developed to continue to advance the state-of-the-art for bonding polymeric trim pieces, e.g., PVC onto metallic garage doors, e.g., steel, in which the coefficient of expansion of the trim and the base substrate more closely match each other.

One of the more recent trends in consumer preference for garage doors is the carriage-house style. These doors typically cost more than standard raised-panel ones, but they add a distinctive touch that many homeowners believe is worth the additional cost.

One of the latest innovations in style calls for steel construction instead of the more traditional wood. Steel offers at least two advantages over wood. First, it costs less and it requires much less maintenance. In order to provide surface relief, there were typically two choices: embossed steel or steel with an overlay. Both simulate the old-fashioned look of doors that swing open from the sides. Of these choices, the lower cost alternative is embossed steel while the more desirable appearance is achieved using steel with a polymeric overlay. These overlays are screwed, nailed or glued on.

While nailing or screwing is the most secure method of adherence, they are also the most costly. When labor costs are high, it is more desirable to use gluing as the methodology of fastening. However, while this may decrease initial labor costs, it presently has drawbacks due to mismatched coefficients of thermal expansion between the steel garage door and the polymeric overlay. In fact, the overlay material could easily “pop-off” due to repeated temperature cycling which is present in most non-tropical environments.

### SUMMARY OF THE INVENTION

The invention is a polymeric overlay structure for a non-wood garage door, such as a steel sectional garage door and a method of making the overlay and applying the overlay to the door whereby the finished overlay pattern has an aesthetically pleasing and professional appearance.

The sectional door has a plurality of rectangular-shaped door sections or panels. Pivot joint assemblies attached to the door panels pivotally connect the door panels. Each door panel has an outer surface made of a non-wood material, such as steel. A custom designed overlay is secured to the outer surface and protrudes outwardly from the outer surface providing the door with a contrasting appearance from the appearance of the outer surface of the door. The overlay has a plurality of linear transverse members extending across the door panel sections. Adhesive material compatible with the outer surface of the door and the overlay members is used to secure the members to the outer surface.

It is an aspect of the present invention to provide a polymeric overlay material which has a coefficient of thermal expansion similar to that of the base metal substrate to which it is applied and affixed thereto, yet which retains its shape at high environmental temperatures without sagging, a characteristic of a material with a high heat distortion temperature.

It is another aspect of this invention to provide the polymeric overlay at a competitive price.

To the accomplishment of the foregoing and related ends the invention, then, comprises the features hereinafter fully described and particularly pointed out in the claims, the following description and the annexed drawings setting forth in detail certain illustrative embodiments of the invention, these being indicative, however, of but a few of the various ways in which the principles of the invention may be employed.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 is perspective view of a garage door with polymeric overlays attached thereto;

FIG. 2 is a graph of the impact of increasing levels of added wood flour at constant Blendex additive amounts upon heat sag (° F.) of the PVC blend;

FIG. 3 is a graph of the impact of increasing levels of added wood flour at constant Blendex additive amounts upon the coefficient of expansion (COE) of the PVC blend;

FIG. 4 is a graph of the impact of increasing levels of added Blendex additive at constant wood flour additive amounts upon the coefficient of expansion of the PVC blend;

FIG. 5 is a graph of the impact of increasing levels of added Blendex additive at constant wood flour additive amounts upon heat sag (° F.) of the PVC blend;

FIG. 6 is a graph of coefficient of expansion (×10⁻⁵ inch/inch/° F.) vs. heat distortion temperature (° F.) illustrating the effect of increasing amounts of Blendex modifier (0-20%) per fixed amount of added wood flour ranging from 0% to 20%, each incremental Blendex data point illustrating 0%, 10%, 15% and 20% respectively on the graph as viewed left to right; and

FIG. 7 is a graph of the coefficient of expansion (×10⁻⁵ inch/inch/° F.) vs. heat distortion temperature (° F.) illustrating the effect of increasing amounts of wood flour (0-20%) per fixed amount of Blendex ranging from 0% to 20%, each incremental wood flour data point illustrating 0%, 10%, 15% and 20% respectively on the graph as viewed left to right.

### DETAILED DESCRIPTION OF THE INVENTION

The invention is described with reference to the accompanying figures, which illustrate the best mode known to the inventor at the time of the filing of the application illustrating the application of polymeric overlays which are glued onto steel doors, particularly garage doors of the invention.

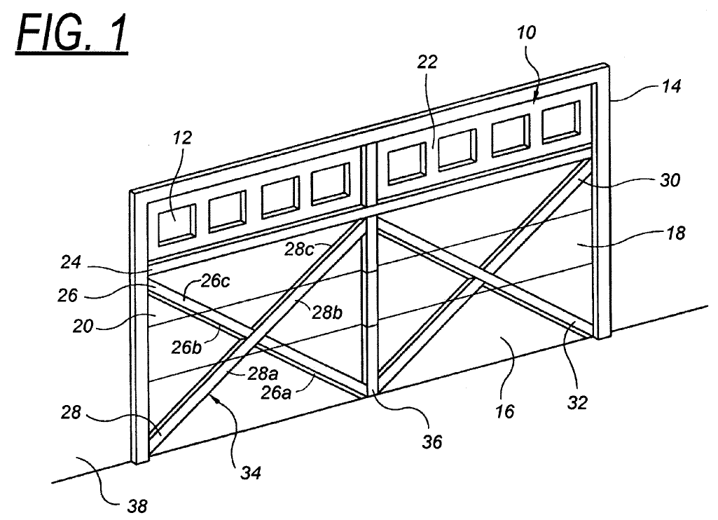

As better illustrated in FIG. 1, a multi panel sectional garage door 10 for ingress and egress from structure 38 is shown having vertical 36, horizontal 24 and angled 34 polymeric overlays affixed thereto. The door is surrounded by an outer frame 14. Door 10 has a plurality of pivotally connected hinged horizontal panels, 16, 18, 20 and 22, the number of which is determined by the height of the garage door and the height of the interior of the garage which has an impact on the retraction angle employed, although typically, this angle is approximately 90°. Top panel 22 optionally has a plurality of windows 12 affixed therein for increasing the conveyance of natural light inside the structure when the door is in its closed position. As illustrated in the figure, each angled or diagonal overlay is designed to mimic a braced look, e.g., 30, 32 shown on the right side of the drawing. Any polymeric overlay which extends over more than one panel is sectioned to permit the door to retract from its closed position to an open position, as illustrated for example by diagonal members 26a, 26b, and 26c as well as 28a, 28b, and 28c. For similar reasons, vertical upright member 36 is also sectioned.

Polymeric overlay carriage house garage doors simulate the historic swing type doors used in early automobile shelters. The pattern of trim boards illustrated in the figure represents but one configuration of a carriage house garage door. It should be apparent to those skilled in the art, that trim boards and/or windows may be arranged differently than what is shown in FIG. 1 to obtain a desired style for the carriage house garage door. For example, trim boards may be arranged in a cross-buck pattern, perimeter pattern, vertical pattern, horizontal pattern, and so forth, while windows may be smaller, larger, include curved tops, and so forth. The garage doors are optionally insulated, often using polystyrene foam board insulation. Each panel section is typically made of 24 gauge galvanized steel, optionally having an acrylic or polyester exterior coating.

Polymeric trim pieces are affixed to the exterior surface of garage door 10 using an adhesive material which is compatible with the material of the outer surface of the door, the finish of the outer surface and with the material of the polymeric overlay. Preferably, this adhesive material is a commercially available construction adhesive, such as PL200 or FYPON construction adhesives, achieving strengths of about 600 pounds per square inch, which is water-resistant and resistant to temperature fluctuations. Optionally, in addition to, or in replacement of said adhesives, fasteners such as pin nails or galvanized sheet metal screws are used to hold overlay members.

A series of trials were undertaken to document the effects of wood flour addition levels, wood flour type, heat distortion temperature modifier type and modifier level on the coefficient of expansion (COE) and heat distortion temperature (° F.) of a PVC blend formulation. These properties are important in the use of extrusion products formed from these compounds when the end use application is a decorative profile attached to the garage door. What has eluded the Prior Art is the ability to manufacture a PVC blend which can be glued onto a steel garage door in which the PVC blend formulation has a coefficient of thermal expansion which is closer to that of metal than to that of traditional polymers, still using low amounts (generally less than 20%) of wood fiber fillers, yet also possess a high heat distortion temperature, at least 180° F., more preferably about 190° F., and most preferably, above 200° F. With the combination of these properties, the polymeric overlay will not expand so much as to cause the piece to “pop-off” the garage door due to its larger coefficient of expansion in comparison to that of the metallic door. Additionally, at these same high temperatures, the polymeric trim piece will not exhibit “sag” which is highly undesirable from a consumer standpoint. Other uses for these overlay pieces include glass surrounds for garage and entrance doors, various extrusions used in the construction of doors and windows and other construction uses where these properties are of a benefit.

Each of the compounds listed in Table II were blended in a high intensity mixer until a temperature of 230° F. was reached and then discharged into a covered container. This served the purpose of intimately mixing the materials, but more importantly, driving much of the moisture from the wood flour. The individual batches were then fed through a metering system into a lab 25 mm conical twin screw extruder in accordance with the conditions in Table I.

TABLE I

| Extruder Conditions | |
|---|---|
| Screw speed (RPM) | 25 |
| Barrel 1 temperature (° F.) | 360 |
| Barrel 2 temperature (° F.) | 350 |
| Gate temperature (° F.) | 350 |
| Die temperature (° F.) | 350 |
| Die dimensions (W × H × L) (in) | 1.0 × 0.16 × 4.0 |

The extrudate strip was hand pulled from the die using minimal force to keep the strip straight and then cooled between two aluminum plates. Three 12 inch samples were cut for each trial with the length measured after heating at 143° F. for 1 hour and then the length was again measured after cooling for one hour at 73° F. The averages of these length changes were used to calculate the coefficient of expansion (COE) given in Table III.

One of each of these samples was then used to obtain the heat sag temperature. The 12 inch samples were supported ¾ inches above a controlled temperature convection oven rack by 2 inches with the remaining 10 inches extending freely over the racks. The temperature was raised 5° F. each 5 minutes until the free end sagged enough to reach the rack. This temperature is reported in Table III as Sag Temperature for each trial sample.

TABLE II
Base PVC Compound Formula (previously blended)

| | PPH |
|---|---|
| Compound Item | (parts per hundred parts resin) |
| PVC Resin (˜68,000 M.W.) | 100 |
| Impact modifiers/process aids | 6.5 |
| Lubricants | 3.2 |
| TiO₂ | 8.5 |
| Filler | 5 |

TABLE III
Final Blend Formula

| | | | | | | | | Heat |
|---|---|---|---|---|---|---|---|---|
| | | Filler | Wood | Modifier | Modifier | Lubri- | | Sag |
| # | PVC % | Type | Flour % | Type | % | cant | COE⁽²⁾ | (T° F.) |
| 1 | 100 | NA | 0 | | 0 | None | 3.9 | 170 |
| 2 | 90 | NA | 0 | AMSAN⁽¹⁾ | 10 | 0 | 3.8 | 180 |
| 3 | 85 | NA | 0 | AMSAN | 15 | 0 | 4.0 | 190 |
| 4 | 80 | NA | 0 | AMSAN | 20 | 0 | 4.1 | 195 |
| 5 | 89.7 | SW⁽⁴⁾ | 10 | | 0 | 0.3 | 3.1 | 175 |
| 6 | 79.7 | SW | 10 | AMSAN | 10 | 0.3 | 2.9 | 185 |
| 7 | 74.7 | SW | 10 | AMSAN | 15 | 0.3 | 2.8 | 190 |
| 8 | 69.7 | SW | 10 | AMSAN | 20 | 0.3 | 2.8 | 195 |
| 9 | 84.5 | SW | 15 | | 0 | 0.5 | 2.5 | 180 |
| 10 | 74.5 | SW | 15 | AMSAN | 10 | 0.5 | 2.7 | 185 |
| 11 | 69.5 | SW | 15 | AMSAN | 15 | 0.5 | 2.5 | 195 |
| 12 | 64.5 | SW | 15 | AMSAN | 20 | 0.5 | 2.5 | 200 |
| 13 | 79.3 | SW | 20 | | 0 | 0.7 | 2.4 | 185 |
| 14 | 69.3 | SW | 20 | AMSAN | 10 | 0.7 | 2.5 | 185 |
| 15 | 64.3 | SW | 20 | AMSAN | 15 | 0.7 | 2.1 | 205 |
| 16 | 59.3 | SW | 20 | AMSAN | 20 | 0.7 | 2.1 | 210 |
| 17 | 74.7 | HW⁽⁵⁾ | 10 | AMSAN | 15 | 0.3 | 2.7 | 190 |
| 18 | 69.5 | HW | 15 | AMSAN | 15 | 0.5 | 2.5 | 185 |
| 19 | 64.3 | HW | 20 | AMSAN | 15 | 0.7 | 2.4 | 200 |
| 20 | 59.2 | HW | 25 | AMSAN | 15 | 0.8 | 2.1 | 205 |
| 21 | 74.5 | SW | 15 | ABS⁽³⁾ | 10 | 0.5 | 2.6 | 185 |
| 22 | 69.5 | SW | 15 | ABS | 15 | 0.5 | 2.7 | 185 |
| 23 | 64.5 | SW | 15 | ABS | 20 | 0.5 | 2.7 | 185 |
| 24 | 59.5 | SW | 15 | ABS | 25 | 0.5 | 2.7 | 185 |

⁽¹⁾Alpha-methylstyrene-co-acrylonitrile copolymer resin
Blendex 587S sold by Crompton
⁽²⁾73° F.-143° F. (×10⁻⁵ inch/inch/° F.)
⁽³⁾Acrylonitrile butadiene styrene terpolymer
⁽⁴⁾American Wood Fibers softwood 6020 (pine)
⁽⁵⁾American Wood Fibers hardwood 6010

The Blendex587S used in the above table was a free flowing white powder with a specific gravity of 1.04 g/cm³, a bulk density of 350 kg/m³, a VICAT B120/49N of 127° C. and a Tg (DSC) of 131° C. While one specific alpha-methylstyrene-co-acrylonitrile copolymer is illustrated, this is but one example of a class of polymers which are useful in the practice of this invention. Generically, the AMSAN polymers have an acrylonitrile content in the range of about 20% to about 40% by weight and a styrene content in the range of about 60% to about 80% by weight. The copolymers of alpha-methylstyrene and acrylonitrile to be prepared according to the invention may contain minor quantities of one or more other monomers in addition. These quantities must be less than 10% by weight with respect to the copolymer, more preferably less than 5% by weight. Examples of such monomers are methacrylonitrile, methyl methacrylate, ethyl acrylate and styrene. It is also possible to prepare the copolymer of alpha-methylstyrene and acrylonitrile in the presence of a rubber, such as polybutadiene, butadiene-styrene rubber, butadiene-acrylonitrile rubber, polychloroprene, acrylate rubber, ethylene-propylene rubber and/or EPDM rubber.

Optionally, and more generically, the styrene(vinylaromatic) component may include copolymers of styrene-co-acrylonitrile (SAN), styrene-co-maleimide (SMSAN), styrene-co-maleic acid (anhydride)/acrylonitrile polymers or styrene-co-maleic anhydride (SMA). The vinylaromatic monomer, preferably styrene includes substituted styrenes or (meth)acrylates or a mixture thereof, particularly of styrene and/or alpha-methylstyrene. The ethylenically unsaturated cyano monomer preferably is acrylonitrile or methacrylonitrile, particularly acrylonitrile.

The hardwood (6010) and softwood (6020) (pine) grade wood flour used above was purchased from American Wood Fibers having the following mesh distribution.

TABLE IV

| Property | 6010 | 6020 |
|---|---|---|
| 40 mesh (425 microns) | Trace | Trace |
| 60 mesh (250 microns) | 0-15% | 0-5% |
| 80 mesh (180 microns) | 0-45% | 0-55% |
| 100 mesh (150 microns) | 5-40% | 15-40% |
| Balance pan | 15-85% | Max 85% |
| Moisture content | Max 6% | Max 8% |
| Typical bulk density (lbs/cu. ft.) | 14 | 8 |
| Typical acidity (pH) | 5.0 | 4.7 |
| Typical specific gravity | 0.54 | 0.4 |
| Typical ash content | 0.7% | 0.5% |

In one example, an ABS terpolymer used above was an amorphous thermoplastic which is hard, rigid and tough, even at low temperatures and was purchased as Royalite R12 from Myers Plastics.

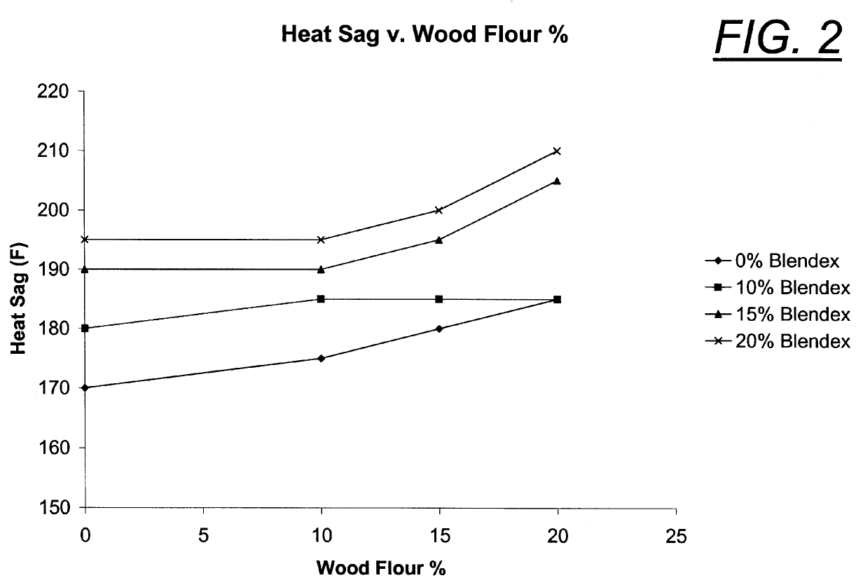

A series of graphs were made to analyze the data presented in the above table. As shown in FIG. 2, increasing amounts of wood flour at constant blended amounts of the modifier Blendex (alpha-methylstyrene-co-acrylonitrile copolymer or AMSAN) did improve the heat sag of the polymer, although at least some Blendex is necessary at the lowest levels of added wood flour in order to achieve the minimum 180° F. heat distortion temperature necessary for effective utilization in garage door applications, which depending on building orientation, may absorb the direct impact of the sun for long periods of time. The highest degree of heat sag resistance was obtained by combining higher levels of Blendex with higher levels of wood flour.

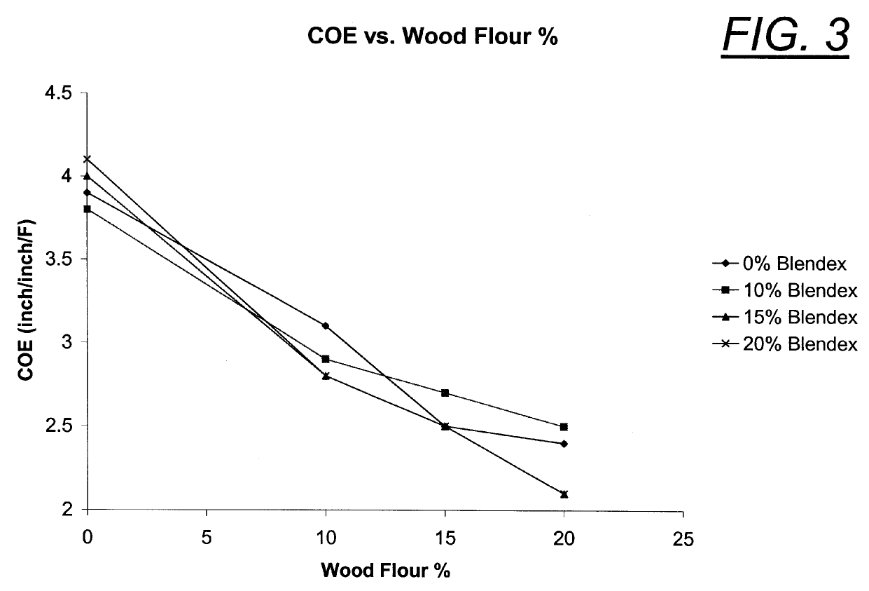

As illustrated in FIG. 3, a similar trend was obtained, with the lower values of coefficient of expansion being achieved with the higher amounts of wood flour and Blendex modifier. For effective utilization in this application, the COE generally must be no greater than about 2.8×10⁻⁵ inch/inch/° F.

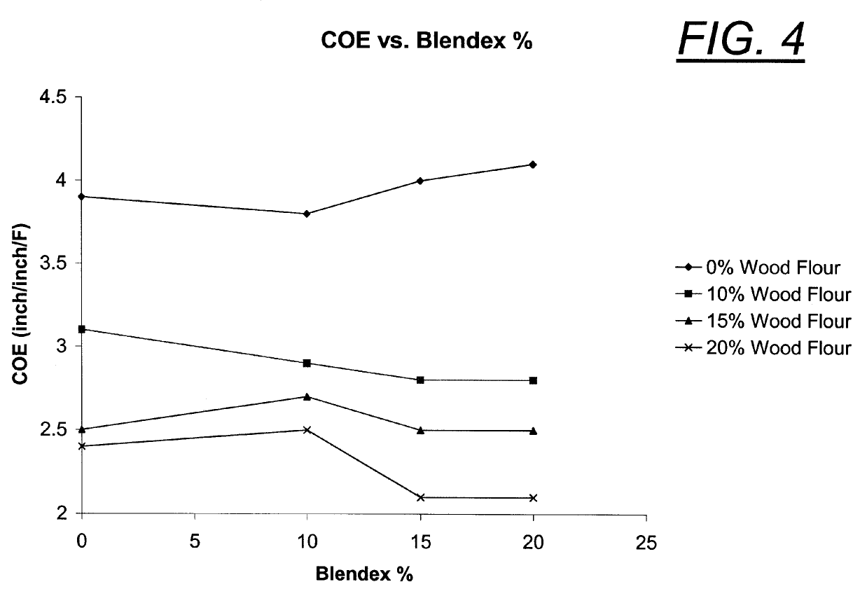

FIG. 4 illustrates the impact of the same data when plotted using constant amounts of wood flour and varying the amount of added Blendex. Similarly, the conclusion is drawn that better performance in this application demands that at least about 15% wood flour be added in order to achieve the lower coefficient of expansion values which are demanded.

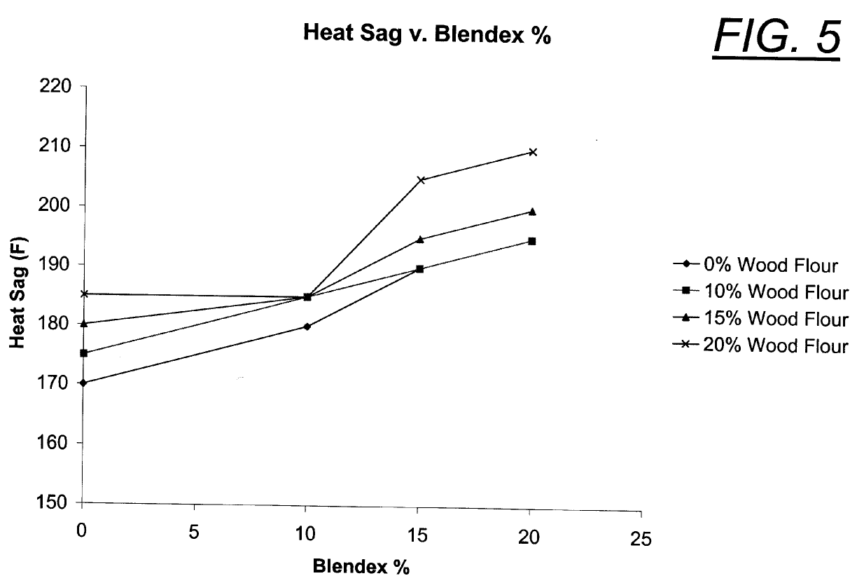

FIG. 5 also indicates that the better performing products are those in which higher levels of both wood flour and Blendex are added, with once again, at least some Blendex and wood flour being required in this application.

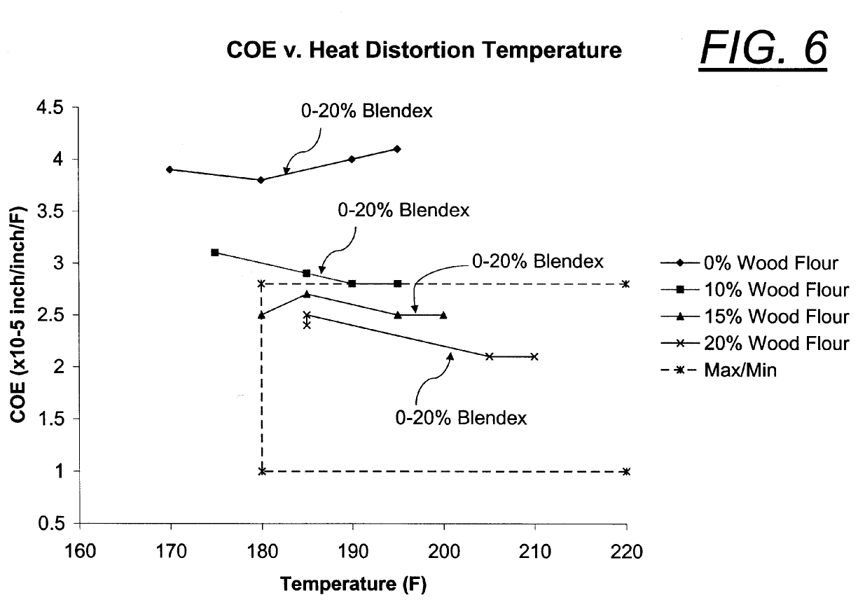

However, since it is the combination of both low coefficient of thermal expansion with higher heat distortion temperatures which are demanded for the application, FIG. 6 better illustrates the combinations of products which successfully meet the criterion. As shown in the Figure, what is sought is a range of products which fall between a maximum/minimum on the graph, illustrated by an open rectangular box. The minimum heat distortion temperature which is generally believed to be successful for this application is about 180° F. and while in theory, there is no lower limit to the coefficient of thermal expansion which would work, a reasonable working number is about 1×10⁻⁵ inch/inch/° F., a value which is similar to that of many metals used in these applications while a high limit of this same parameter is generally believed to be about 2.8×10⁻⁵ inch/inch/° F. As viewed with this double set of criteria in place, it is seen that combinations such as 15-20% Blendex in combination with at least 10% wood flour meet the criteria. Similarly, all ranges of added Blendex in combination with 15-20% wood flour met the criteria.

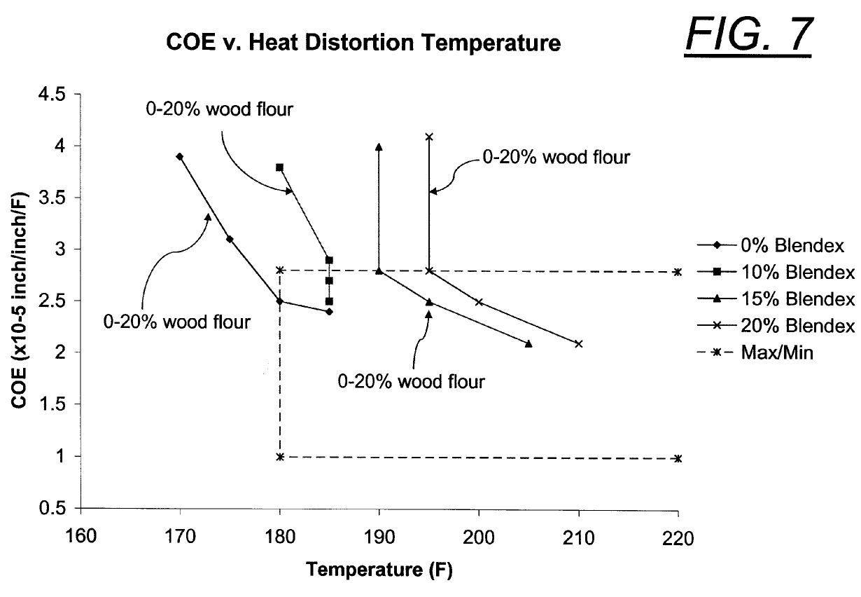

FIG. 7 illustrates the dual criteria concept initially introduced in FIG. 6, the difference being that the amount of Blendex is constant, while the amount of added wood flour varies from 0 to 20%, the trend of added wood flour being generally indicated by desirably decreasing the coefficient of expansion while often increasing the heat distortion temperature. Once again, the range of working combinations of modifier plus wood flour filler being illustrated within the open rectangular box illustrated by the Max/Min legend.

As illustrated in Table III, it can be seen that increasing the Blendex 587S content in the neat polymer (Trials 1 through 4) increases the heat sag by up to 25° F. In addition to the direct effect of the wood flour to reduce COE, there is shown a surprising change in COE with Blendex. With no wood flour present, increasing amounts of Blendex have a small detrimental effect on the coefficient of expansion. However, at high wood flour levels, the effect is reversed whereby the higher levels of Blendex actually improve the COE. Additionally, wood fiber has a positive impact on the heat sag as compared to Blendex. This is not surprising since wood fiber increases the flexural modulus that should add resistance to sagging.

Additional trials were run to compare the addition of an ABS polymer to the Blendex as well as hardwood wood flour to softwood wood flour. The addition of ABS (Dow 9030) at all levels from 10 to 25% and 15% pine flour showed the same heat sag temperature which was about the same as the 15% pine wood flour with no Blendex. The use of hardwood-based flour rather than pine-based flour showed at the 20% wood flour level with 15% Blendex, the pine was more effective in reducing COE but 25% hardwood flour provided an equivalent COE to the 20% pine flour.

It is recognized that the composition of the invention may further comprise effective amounts of one or more of the following: antioxidants, lubricants, ultraviolet light stabilizers, thermal stabilizers, pigments, such as titanium dioxide and other additives. Precise amounts of such additives can be included in the mixture from which the substantially uniform blend is made.

In the foregoing description, certain terms have been used for brevity, clearness and understanding; but no unnecessary limitations are to be implied there from beyond the requirements of the Prior Art, because such terms are used for descriptive purposes and are intended to be broadly construed. Moreover, the description and illustration of the invention is by way of example, and the scope of the invention is not limited to the exact details shown or described. This invention has been described in detail with reference to specific embodiments thereof, including the respective best modes for carrying out each embodiment. It shall be understood that these illustrations are by way of example and not by way of limitation.

1. A polyvinyl chloride blend comprising:
about 1-20 weight percent of a copolymer comprising
a polymer derived from a vinylaromatic monomer and
a polymer derived from an ethylenically unsaturated cyano monomer;
about 1-20 weight percent of wood flour; and
wherein said combination of said copolymer and said wood flour when blended into said polyvinyl chloride have a coefficient of expansion less than or equal to 2.8×10-5 inch/inch/° F. and a heat distortion temperature of at least 180° F.

2. The blend of claim 1 wherein
said vinylaromatic monomer is styrene and
said ethylenically unsaturated cyano monomer is acrylonitrile.

3. The blend of claim 1 wherein
said vinylaromatic monomer is alpha-methylstyrene and
said ethylenically unsaturated cyano monomer is acrylonitrile.

4. The blend of claim 3 wherein
said wood flour is a softwood.

5. A polyvinyl chloride blend comprising:
about 10-20 weight percent of a styrene-co-acrylonitrile copolymer;
about 10-20 weight percent of wood flour; and
wherein said combination of said copolymer and said wood flour when blended into said polyvinyl chloride have a coefficient of expansion less than or equal to 2.7×10-5 inch/inch/° F. and a heat distortion temperature of at least 190° F.

6. The blend of claim 5 wherein
said styrene-co-acrylonitrile copolymer is alpha-methylstyrene-co-acrylonitrile.

7. The blend of claim 5 wherein
said wood flour is a softwood.

8. A polyvinyl chloride blend comprising:
about 10-20 weight percent of alpha-methylstyrene acrylonitrile copolymer;
about 10-20 weight percent of wood flour; and
wherein said combination of said alpha-methylstyrene-co-acrylonitrile copolymer and said wood flour when blended into said polyvinyl chloride have a coefficient of expansion less than or equal to 2.5×10-5 inch/inch/° F. and a heat distortion temperature of at least 190° F.

9. The blend of claim 8 wherein
said wood flour is a softwood.

10. A process for simultaneously increasing the heat distortion temperature and lowering the coefficient of thermal expansion of a polyvinyl chloride blend which comprises the steps of:
adding about 1-20 weight percent of a copolymer comprising
a polymer derived from a vinylaromatic monomer and
a polymer derived from an ethylenically unsaturated cyano monomer;
adding about 1-20 weight percent of wood flour; and
wherein said combination of said copolymer and said wood flour when blended into said polyvinyl chloride have a coefficient of expansion less than or equal to 2.8×10⁻⁵ inch/inch/° F. and a heat distortion temperature of at least 180° F.

11. The process of claim 10 wherein
said vinylaromatic monomer is styrene and
said ethylenically unsaturated cyano monomer is acrylonitrile.

12. The process of claim 10 wherein
said vinylaromatic monomer is alpha-methylstyrene and
said ethylenically unsaturated cyano monomer is acrylonitrile.

13. The process of claim 12 wherein
said wood flour is a softwood.

14. A process for simultaneously increasing the heat distortion temperature and lowering the coefficient of thermal expansion of a polyvinyl chloride blend which comprises the steps of:
adding about 10-20 weight percent of a styrene-co-acrylonitrile copolymer;
adding about 10-20 weight percent of wood flour; and
wherein said combination of said copolymer and said wood flour when blended into said polyvinyl chloride have a coefficient of expansion less than or equal to 2.7×10⁻⁵ inch/inch/° F. and a heat distortion temperature of at least 190° F.

15. The process of claim 14 wherein
said styrene-co-acrylonitrile copolymer is alpha-methylstyrene-co-acrylonitrile.

16. The process of claim 15 wherein
said wood flour is a softwood.

17. A process for simultaneously increasing the heat distortion temperature and lowering the coefficient of thermal expansion of a polyvinyl chloride blend which comprises the steps of:
adding about 10-20 weight percent of alpha-methylstyrene acrylonitrile copolymer;
adding about 10-20 weight percent of wood flour; and
wherein said combination of said alpha-methylstyrene-co-acrylonitrile copolymer and said wood flour when blended into said polyvinyl chloride have a coefficient of expansion less than or equal to 2.5×10⁻⁵ inch/inch/° F. and a heat distortion temperature of at least 190° F.

18. The process of claim 17 wherein
said wood flour is a softwood.
